(19) United States
(12) Patent Application Publication
(10) Pub. No.: US 2003/0002796 A1
(43) Pub. Date: Jan. 2, 2003

(54) Optical waveguide

(76) Inventors: Thomas Kupper, Bad Gandersheim (DE); Lars Bewig, Bad Gandersheim (DE)

Correspondence Address: BAKER & DANIELS, 111 E. WAYNE STREET, SUITE 800, FORT WAYNE, IN, 46802

(21) Appl. No.: 10/134,291

(22) Filed: Apr. 29, 2002

(30) Foreign Application Priority Data
May 22, 2001 (DE) 101 25 152.1

(51) Int. Cl. G02B 6/26; G02B 6/02

(52) U.S. Cl. 385/38; 385/31; 385/123

(57) ABSTRACT

The invention relates to an optical waveguide with at least one fiber, especially a synthetic fiber, glass or quartz fiber, where the fiber comprises a fiber end for coupling in light.

The invention is characterized in that the fiber end comprises an infrared-reducing coating.

The invention relates to an optical waveguide with one or more fibers, especially glass, quartz or synthetic fibers.

Today, optical waveguides are playing an increasingly important role in optical data transmission, but also for purposes of illumination. Such optical waveguides comprise at least one fiber, but frequently one or more bundles of fibers by means of which light waves are transmitted from one end of the optical waveguide to the other end. To achieve this, light must be coupled into the optical fiber at one end of the optical waveguide. Reflectors are usually used for such light coupling, where the fiber or the fiber end is fixed in focus.

In order to keep the high infrared proportions of halogen light sources (and also of discharge lamps) away from the fiber, said reflectors are mostly configured as cold-light reflectors having an infrared residual reflection of typically less than 20 percent. The use of increasingly higher wattages for illumination sources, however, still makes additional filters necessary for reducing the infrared stress on the fiber so as to prevent that the fiber is destroyed.

Particularly when optical waveguides with synthetic fibers are used, which are especially cost-effective and easy to produce, the fibers or the fiber ends are highly at risk as a result of excessive infrared irradiation, because synthetic fibers are even more heat sensitive than glass fibers, for example. In addition, synthetic fibers are usually UV-sensitive and become brittle as a result of UV irradiation.

The aim of the invention is to provide an optical waveguide that is more resistant to damaging light radiation and that can be produced more cost-effectively.

The problem is solved by means of an optical waveguide having the features of claim 1. The dependent claims specify especially advantageous embodiments.

The optical waveguide of the invention comprises at least one fiber, especially synthetic fiber, glass or quartz fiber. The fiber comprises a fiber end for coupling in light. Light can be coupled in as described above by means of reflectors, for example. A coating with an infrared-reducing property is applied to the fiber end. Said infrared reduction can take place by means of reflecting the infrared portion of the irradiated light, for example.

The configuration of the optical waveguide in accordance with the invention considerably reduces the infrared stress on the fiber, and additional infrared filters between the reflectors and the fiber are not required.

With the coating of the invention even synthetic fibers can easily be used for fiber optic transmission.

However, such synthetic fibers are additionally at risk due to UV (ultraviolet) radiation, because UV radiation makes the synthetic material brittle. Therefore, according to an especially advantageous embodiment of the invention the coating of the fiber end additionally has UV-reflecting or UV-absorbing, generally UV-reducing properties. The coating can be provided with such properties, for example, by using TiO₂ as a constituent of the coating because said constituent represents an especially effective UV-blocker. A configuration of the fiber end, where silver diffusion paint is applied as a coating constituent is also advantageous.

Especially advantageously, the coating can be an IRC coating, which is currently state of the art for halogen lamp bulbs. Such a coating has the advantage of having an anti-reflection function in addition to the high IR reflectivity in the visible wavelength range. Said anti-reflection function increases the quantity of light coupled into optical waveguides with illumination fibers and minimizes the reflections on data transmission fibers, which lead to transmission errors.

In particular, the fiber end additionally comprises a non-scratch coating so as to reduce the sensitivity to mechanical damage.

Advantageously, it is also possible to insert color conversion filters into the coating. When such a layer system is applied the coating can be specifically provided with special properties, such as color temperature adaptation or the coupling of spectrally narrow-band illumination.

According to a special embodiment, the fiber end has a plurality of coatings with varying refraction coefficients. Such a coating is able to transmit the visible radiation and reflect the infrared radiation especially easily.

The coating is preferably applied to the fiber ends, especially of synthetic fibers, by means of the PICVD method, which ensures a particularly reliable stability of the coating on the fiber and facilitates production. This makes it especially easy to provide the synthetic fiber with a non-scratch coating at the ends.

However, other methods for applying the coating on the synthetic fiber or on fibers consisting of other materials are also conceivable, such as the PVD and the sputtering methods (reactive and non-reactive), LPCVD and plasma enhanced methods, to name a few.

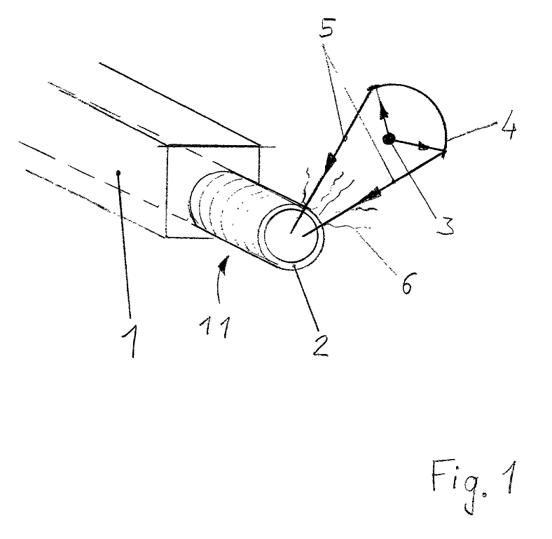

The invention is discussed below in more detail by means of a graphic illustration and the pertaining specification, as follows: FIG. 1 shows an optical waveguide of the invention.

FIG. 1 shows a fiber 1 in an optical waveguide whose fiber end 1.1 projects over the optical waveguide at one end. Light is coupled into the fiber end 1.1 by means of a light source 3 and a reflector 4, which can be especially configured as a cold-light reflector.

The light emitted by the light source 3 is focused via the reflector 4. The fiber end 1.1 of the fiber of the optical waveguide is connected to the focus of the reflector 4, so that the reflected or focused light waves 5 are virtually completely coupled into the fiber end 1.1.

The fiber end 1.1 is provided with an infrared-reducing coating 2. The coating 2 has infrared-reflecting properties, so that the infrared range of the light focusing on the fiber end 1.1 is reflected by the coating 2 and thus it is kept away from the fiber end 1.1. The reflection of the infrared light is shown as a serpentine identified by reference number 6.

Because this virtually fully prevents heat penetration in the fiber end 1.1 a cost-effective synthetic fiber can also be used for fiber optic transmission.

Reference List

| | |
|---|---|
| 1 | Fiber |
| 1.1 | Fiber end |
| 2 | Coating |
| 3 | Light source |
| 4 | Reflector |
| 5 | Light waves |
| 6 | Infrared reflection |

1. Optical waveguide with at least one fiber (1), especially synthetic fiber, glass or quartz fiber;
1.1 the fiber (1) comprises a fiber end (1.1) for coupling in light, characterized in that
1.2 the fiber end (1.1) comprises an infrared-reducing coating (2).

2. Optical waveguide as defined in claim 1, characterized in that the fiber end (1.1) comprises an IR-reflecting coating.

3. Optical waveguide as defined in any of the claims 1 or 2, characterized in that the coating (2) has UV-reflecting properties.

4. Optical waveguide as defined in any of the claims 1 to 3, characterized in that the coating (2) has UV-absorbing properties.

5. Optical waveguide as defined in any of the claims 3 or 4, characterized in that the coating (2) comprises a silver diffusion paint and especially layer packages consisting of TiO_{2 as UV-blockers.}

6. Optical waveguide as defined in any of the claims 1 to 5, characterized in that the coating (2) has anti-reflection properties in the visible wave range.

7. Optical waveguide as defined in any of the claims 1 to 6, characterized in that the fiber end (1.1) comprises a non-scratch coating.

8. Optical waveguide as defined in any of the claims 1 to 7, characterized in that the coating (2) comprises a color conversion filter.

9. Optical waveguide as defined in any of the claims 1 to 8, characterized in that the fiber end (1.1) comprises a plurality of layers with varying refraction coefficients.

10. Optical waveguide as defined in any of the claims 1 to 9, characterized in that the coating (2) is applied to the fiber end (1.1) by means of at least one of the following methods:
PICVD (Plasma Impulse Chemical Vapor Deposition)
LPCVD (Low Pressure Chemical Vapor Deposition)
PECVD (Plasma Enhanced Chemical Vapor Deposition)
Reactive and non-reactive sputtering methods
PVD method
